(19) United States
(12) Patent Application Publication
(10) Pub. No.: US 2022/0177274 A1
(43) Pub. Date: Jun. 9, 2022

(54) ROPELESS ELEVATOR VEHICLE WORKSTATION

(71) Applicant: Otis Elevator Company, Farmington, CT (US)

(72) Inventors: Randy Roberts, Hebron, CT (US); Kiron Bhaskar, Farmington, CT (US)

(21) Appl. No.: 17/112,574

(22) Filed: Dec. 4, 2020

(51) Int. Cl. B66B 9/00; B66B 7/02; B66B 7/04

(52) U.S. Cl. CPC B66B 9/003; B66B 7/046; B66B 7/021

(57) ABSTRACT

A system for transferring elevator cars from a first elevator shaft to a second elevator shaft including: a first propulsion system configured to move a first elevator car through the first elevator shaft; a transfer carriage configured to move the first elevator car and the first propulsion system from the first elevator shaft to the second elevator shaft through a transfer station, the transfer carriage including: an elevator car containment slot to receive the first elevator car and the first propulsion system when the elevator car containment slot is aligned with the first elevator shaft, wherein the first propulsion system is configured to move the first elevator car and the first propulsion system from an elevator system within the first elevator shaft onto the transfer carriage to a vehicle workstation.

### BACKGROUND

The subject matter disclosed herein relates generally to the field of elevator systems, and specifically to a method and apparatus for moving elevator cars from an elevator shaft to a workstation.

Elevator cars are conventionally operated by ropes and counter weights, which typically only allow one elevator car in an elevator shaft at a single time. Ropeless elevator systems may allow for more than one elevator car in the elevator shaft at a single time.

### BRIEF SUMMARY

According to an embodiment, a system for transferring elevator cars from a first elevator shaft to a second elevator shaft is provided. The system including: a first propulsion system configured to move a first elevator car through the first elevator shaft; a transfer carriage configured to move the first elevator car and the first propulsion system from the first elevator shaft to the second elevator shaft through a transfer station, the transfer carriage including: an elevator car containment slot to receive the first elevator car and the first propulsion system when the elevator car containment slot is aligned with the first elevator shaft, wherein the first propulsion system is configured to move the first elevator car and the first propulsion system from an elevator system within the first elevator shaft onto the transfer carriage to a vehicle workstation.

In addition to one or more of the features described herein, or as an alternative, further embodiments may include that the vehicle workstation is located on a landing below the transfer station, a landing above the transfer station or on the same landing as the transfer station.

In addition to one or more of the features described herein, or as an alternative, further embodiments may include that the vehicle workstation is located within the second elevator shaft, and wherein transfer carriage is configured to move from the second elevator shaft to a third elevator shaft through transfer station to receive a second elevator car and a second propulsion system from a spare vehicle station.

In addition to one or more of the features described herein, or as an alternative, further embodiments may include a first guide beam that extends vertically through the first elevator shaft, the first guide beam including a first surface and a second surface opposite the first surface, wherein the first propulsion system is a first beam climber system including: a first wheel in contact with the first surface; and a first electric motor configured to rotate the first wheel.

In addition to one or more of the features described herein, or as an alternative, further embodiments may include that the elevator car containment slot further includes: a first containment slot guide beam configured to align with the first guide beam.

In addition to one or more of the features described herein, or as an alternative, further embodiments may include a first guide rail that extends vertically through the first elevator shaft, wherein the elevator car containment slot further includes: a first containment slot guide rail configured to align with the first guide rail.

In addition to one or more of the features described herein, or as an alternative, further embodiments may include a second guide beam that extends vertically through the first elevator shaft, the second guide beam including a first surface of the second guide beam and a second surface of the second guide beam opposite the first surface of the second guide beam, wherein the first beam climber system further includes: a second wheel in contact with the second surface of the first guide beam; a third wheel in contact with the first surface of the second guide beam; and a second electric motor configured to rotate the third wheel.

In addition to one or more of the features described herein, or as an alternative, further embodiments may include that the elevator car containment slot further includes: a second containment slot guide beam configured to align with the second guide beam.

In addition to one or more of the features described herein, or as an alternative, further embodiments may include a second guide beam that extends vertically through the first elevator shaft, the second guide beam including a first surface of the second guide beam and a second surface of the second guide beam opposite the first surface of the second guide beam, wherein the first beam climber system further includes: a second wheel in contact with the second surface of the first guide beam; a third wheel in contact with the first surface of the second guide beam; and a second electric motor configured to rotate the third wheel.

In addition to one or more of the features described herein, or as an alternative, further embodiments may include that the elevator car containment slot further includes: a second containment slot guide beam configured to align with the second guide beam.

In addition to one or more of the features described herein, or as an alternative, further embodiments may include a second guide rail that extends vertically through the first elevator shaft, wherein the elevator car containment slot further includes: a second containment slot guide rail configured to align with the second guide rail.

According to another embedment, a method of moving elevator cars amongst elevator shafts is provided. The method including: moving a transfer carriage to a first elevator shaft to pick up a first elevator car and a first propulsion system; aligning an elevator car containment slot within the transfer carriage with the first elevator shaft; moving, using the first propulsion system, the first elevator car and the first propulsion system from the first elevator shaft into the elevator car containment slot; and moving the transfer carriage with the first elevator car and the first propulsion system within the elevator car containment slot from the first elevator shaft to a vehicle workstation.

In addition to one or more of the features described herein, or as an alternative, further embodiments may include that the vehicle workstation is located in a second elevator shaft, and wherein the method further includes: aligning the elevator car containment slot within the transfer carriage with the second elevator shaft; and moving, using the first propulsion system, the first elevator car and the first propulsion system from the elevator car containment slot into the vehicle workstation within the second elevator shaft.

In addition to one or more of the features described herein, or as an alternative, further embodiments may include: moving the transfer carriage from the second elevator shaft to a third elevator shaft to pick up a second elevator car and a second propulsion system in a spare vehicle station within the third elevator shaft; aligning the elevator car containment slot within the transfer carriage with the third elevator shaft; and moving, using the second propulsion system, the second elevator car and the second propulsion system from the spare vehicle station within the third elevator shaft into the elevator car containment slot.

In addition to one or more of the features described herein, or as an alternative, further embodiments may include: moving the transfer carriage with the second elevator car and the second propulsion system within the elevator car containment slot from the third elevator shaft into service.

In addition to one or more of the features described herein, or as an alternative, further embodiments may include that the moving, using the first propulsion system, the first elevator car and the first propulsion system from the first elevator shaft into the elevator car containment slot further includes: rotating, using a first electric motor of a first beam climber system, a first wheel, the first wheel being in contact with a first surface of a first guide beam that extends vertically through the first elevator shaft.

In addition to one or more of the features described herein, or as an alternative, further embodiments may include: aligning a first containment slot guide beam of the elevator car containment slot with the first guide beam.

In addition to one or more of the features described herein, or as an alternative, further embodiments may include: aligning a first containment slot guide rail of the elevator car containment slot with a first guide rail that extends vertically through the first elevator shaft.

In addition to one or more of the features described herein, or as an alternative, further embodiments may include that the moving, using the first propulsion system, the first elevator car and the first propulsion system from the first elevator shaft into the elevator car containment slot further includes: rotating a second wheel, the second wheel being in contact with the second surface of the first guide beam that extends vertically through the elevator shaft; and rotating, using a second electric motor of the beam climber system, a third wheel, the third wheel being in contact with a first surface of a second guide beam that extends vertically through the first elevator shaft.

According to another embodiment, a computer program product embodied on a non-transitory computer readable medium is provided. The computer program product including instructions that, when executed by a processor, cause the processor to perform operations including: moving a transfer carriage to a first elevator shaft to pick up a first elevator car and a first propulsion system; aligning an elevator car containment slot within the transfer carriage with the first elevator shaft; moving, using the first propulsion system, the first elevator car and the first propulsion system from the first elevator shaft into the elevator car containment slot; and moving the transfer carriage with the first elevator car and the first propulsion system within the elevator car containment slot from the first elevator shaft to a vehicle workstation.

Technical effects of embodiments of the present disclosure include moving an elevator car from an elevator lane into and/or out of a vehicle workstation and/or a spare vehicle station using a transfer carriage.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system with a beam climber system, in accordance with an embodiment of the disclosure;

FIG. 2A-2F illustrates a transfer station system within an upper transfer station, in accordance with an embodiment of the disclosure;

FIG. 3A-3F illustrates a transfer station system within an upper transfer station, in accordance with an embodiment of the disclosure; and

FIG. 4 is a flow chart of a method of moving elevator cars amongst elevator shafts, in accordance with an embodiment of the disclosure.

### DETAILED DESCRIPTION

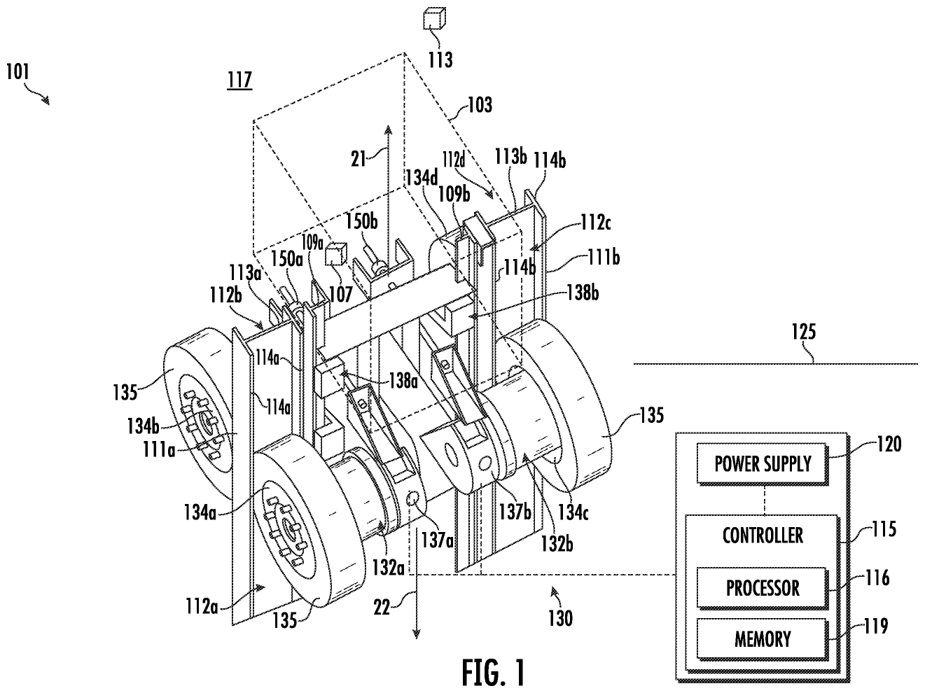

FIG. 1 is a perspective view of an elevator system 101 including an elevator car 103, a beam climber system 130, a controller 115, and a power source 120. Although illustrated in FIG. 1 as separate from the beam climber system 130, the embodiments described herein may be applicable to a controller 115 included in the beam climber system 130 (i.e., moving through an elevator shaft 117 with the beam climber system 130) and may also be applicable to a controller located off of the beam climber system 130 (i.e., remotely connected to the beam climber system 130 and stationary relative to the beam climber system 130). Although illustrated in FIG. 1 as separate from the beam climber system 130, the embodiments described herein may be applicable to a power source 120 included in the beam climber system 130 (i.e., moving through the elevator shaft 117 with the beam climber system 130) and may also be applicable to a power source located off of the beam climber system 130 (i.e., remotely connected to the beam climber system 130 and stationary relative to the beam climber system 130).

The beam climber system 130 is configured to move the elevator car 103 within the elevator shaft 117 and along guide rails 109a, 109b that extend vertically through the elevator shaft 117. In an embodiment, the guide rails 109a, 109b are T-beams. The beam climber system 130 includes one or more electric motors 132a, 132b. The electric motors 132a, 132b are configured to move the beam climber system 130 within the elevator shaft 117 by rotating one or more wheels 134a, 134b that are pressed against a guide beam 111a, 111b. In an embodiment, the guide beams 111a, 111b are I-beams. It is understood that while an I-beam is illustrated, any beam or similar structure may be utilized with the embodiment described herein. Friction between the wheels 134a, 134b, 134c, 134d driven by the electric motors 132a, 132b allows the wheels 134a, 134b, 134c, 134d to climb up 21 and down 22 the guide beams 111a, 111b. The guide beam extends vertically through the elevator shaft 117. It is understood that while two guide beams 111a, 111b are illustrated, the embodiments disclosed herein may be utilized with one or more guide beams. It is also understood that while two electric motors 132a, 132b are illustrated, the embodiments disclosed herein may be applicable to beam climber systems 130 having one or more electric motors. For example, the beam climber system 130 may have one electric motor for each of the four wheels 134a, 134b, 134c, 134d. The electrical motors 132a, 132b may be permanent magnet electrical motors, asynchronous motor, or any electrical motor known to one of skill in the art. In other embodiments, not illustrated herein, another configuration could have the powered wheels at two different vertical locations (i.e., at bottom and top of an elevator car 103).

The first guide beam 111a includes a web portion 113a and two flange portions 114a. The web portion 113a of the first guide beam 111a includes a first surface 112a and a second surface 112b opposite the first surface 112a. A first wheel 134a is in contact with the first surface 112a and a second wheel 134b is in contact with the second surface 112b. The first wheel 134a may be in contact with the first surface 112a through a tire 135 and the second wheel 134b may be in contact with the second surface 112b through a tire 135. The first wheel 134a is compressed against the first surface 112a of the first guide beam 111a by a first compression mechanism 150a and the second wheel 134b is compressed against the second surface 112b of the first guide beam 111a by the first compression mechanism 150a. The first compression mechanism 150a compresses the first wheel 134a and the second wheel 134b together to clamp onto the web portion 113a of the first guide beam 111a. The first compression mechanism 150a may be a metallic or elastomeric spring mechanism, a pneumatic mechanism, a hydraulic mechanism, a turnbuckle mechanism, an electromechanical actuator mechanism, a spring system, a hydraulic cylinder, a motorized spring setup, or any other known force actuation method. The first compression mechanism 150a may be adjustable in real-time during operation of the elevator system 101 to control compression of the first wheel 134a and the second wheel 134b on the first guide beam 111a. The first wheel 134a and the second wheel 134b may each include a tire 135 to increase traction with the first guide beam 111a.

The first surface 112a and the second surface 112b extend vertically through the shaft 117, thus creating a track for the first wheel 134a and the second wheel 134b to ride on. The flange portions 114a may work as guardrails to help guide the wheels 134a, 134b along this track and thus help prevent the wheels 134a, 134b from running off track.

The first electric motor 132a is configured to rotate the first wheel 134a to climb up 21 or down 22 the first guide beam 111a. The first electric motor 132a may also include a first motor brake 137a to slow and stop rotation of the first electric motor 132a. The first motor brake 137a may be mechanically connected to the first electric motor 132a. The first motor brake 137a may be a clutch system, a disc brake system, a drum brake system, a brake on a rotor of the first electric motor 132a, an electronic braking, an Eddy current brakes, a Magnetorheological fluid brake or any other known braking system. The beam climber system 130 may also include a first guide rail brake 138a operably connected to the first guide rail 109a. The first guide rail brake 138a is configured to slow movement of the beam climber system 130 by clamping onto the first guide rail 109a. The first guide rail brake 138a may be a caliper brake acting on the first guide rail 109a on the beam climber system 130, or caliper brakes acting on the first guide rail 109 proximate the elevator car 103.

The second guide beam 111b includes a web portion 113b and two flange portions 114b. The web portion 113b of the second guide beam 111b includes a first surface 112c and a second surface 112d opposite the first surface 112c. A third wheel 134c is in contact with the first surface 112c and a fourth wheel 134d is in contact with the second surface 112d. The third wheel 134c may be in contact with the first surface 112c through a tire 135 and the fourth wheel 134d may be in contact with the second surface 112d through a tire 135. A third wheel 134c is compressed against the first surface 112c of the second guide beam 111b by a second compression mechanism 150b and a fourth wheel 134d is compressed against the second surface 112d of the second guide beam 111b by the second compression mechanism 150b. The second compression mechanism 150b compresses the third wheel 134c and the fourth wheel 134d together to clamp onto the web portion 113b of the second guide beam 111b. The second compression mechanism 150b may be a spring mechanism, turnbuckle mechanism, an actuator mechanism, a spring system, a hydraulic cylinder, and/or a motorized spring setup. The second compression mechanism 150b may be adjustable in real-time during operation of the elevator system 101 to control compression of the third wheel 134c and the fourth wheel 134d on the second guide beam 111b. The third wheel 134c and the fourth wheel 134d may each include a tire 135 to increase traction with the second guide beam 111b.

The first surface 112c and the second surface 112d extend vertically through the shaft 117, thus creating a track for the third wheel 134c and the fourth wheel 134d to ride on. The flange portions 114b may work as guardrails to help guide the wheels 134c, 134d along this track and thus help prevent the wheels 134c, 134d from running off track.

The second electric motor 132b is configured to rotate the third wheel 134c to climb up 21 or down 22 the second guide beam 111b. The second electric motor 132b may also include a second motor brake 137b to slow and stop rotation of the second electric motor 132b. The second motor brake 137b may be mechanically connected to the second electric motor 132b. The second motor brake 137b may be a clutch system, a disc brake system, drum brake system, a brake on a rotor of the second electric motor 132b, an electronic braking, an Eddy current brake, a Magnetorheological fluid brake, or any other known braking system. The beam climber system 130 includes a second guide rail brake 138b operably connected to the second guide rail 109b. The second guide rail brake 138b is configured to slow movement of the beam climber system 130 by clamping onto the second guide rail 109b. The second guide rail brake 138b may be a caliper brake acting on the first guide rail 109a on the beam climber system 130, or caliper brakes acting on the first guide rail 109a proximate the elevator car 103.

The elevator system 101 may also include a position reference system 113. The position reference system 113 may be mounted on a fixed part at the top of the elevator shaft 117, such as on a support or guide rail 109, and may be configured to provide position signals related to a position of the elevator car 103 within the elevator shaft 117. In other embodiments, the position reference system 113 may be directly mounted to a moving component of the elevator system (e.g., the elevator car 103 or the beam climber system 130), or may be located in other positions and/or configurations as known in the art. The position reference system 113 can be any device or mechanism for monitoring a position of an elevator car within the elevator shaft 117, as known in the art. For example, without limitation, the position reference system 113 can be an encoder, sensor, accelerometer, altimeter, pressure sensor, range finder, or other system and can include velocity sensing, absolute position sensing, etc., as will be appreciated by those of skill in the art.

The controller 115 may be an electronic controller including a processor 116 and an associated memory 119 comprising computer-executable instructions that, when executed by the processor 116, cause the processor 116 to perform various operations. The processor 116 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 119 may be but is not limited to a random access memory (RAM), read only memory (ROM), or other electronic, optical, magnetic or any other computer readable medium.

The controller 115 is configured to control the operation of the elevator car 103 and the beam climber system 130. For example, the controller 115 may provide drive signals to the beam climber system 130 to control the acceleration, deceleration, leveling, stopping, etc. of the elevator car 103.

The controller 115 may also be configured to receive position signals from the position reference system 113 or any other desired position reference device.

When moving up 21 or down 22 within the elevator shaft 117 along the guide rails 109a, 109b, the elevator car 103 may stop at one or more landings 125 as controlled by the controller 115. In one embodiment, the controller 115 may be located remotely or in the cloud. In another embodiment, the controller 115 may be located on the beam climber system 130. In embodiment, the controller 115 controls on-board motion control of the beam climber system 130 (e.g., a supervisory function above the individual motor controllers).

The power supply 120 for the elevator system 101 may be any power source, including a power grid and/or battery power which, in combination with other components, is supplied to the beam climber system 130. In one embodiment, power source 120 may be located on the beam climber system 130. In an embodiment, the power supply 120 is a battery that is included in the beam climber system 130.

The elevator system 101 may also include an accelerometer 107 attached to the elevator car 103 or the beam climber system 130. The accelerometer 107 is configured to detect an acceleration and/or a speed of the elevator car 103 and the beam climber system 130.

It is understood that while a beam climber system 130 is illustrated herein for exemplary discussion, the embodiments disclosed herein may be applicable to other multi-car and/or ropeless linear motor driven propulsion systems, such as, for example, a permanent magnet motor propulsion system.

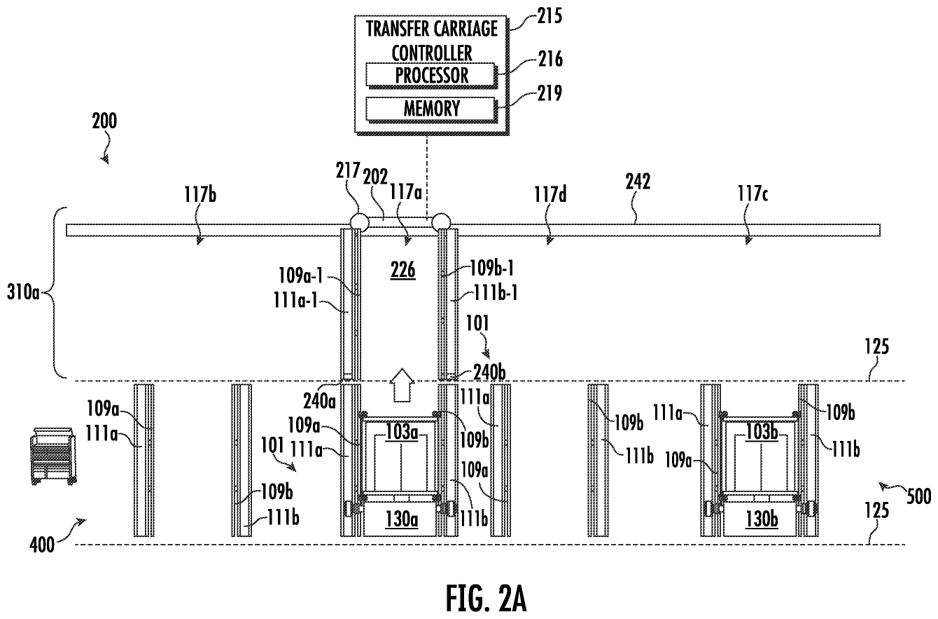

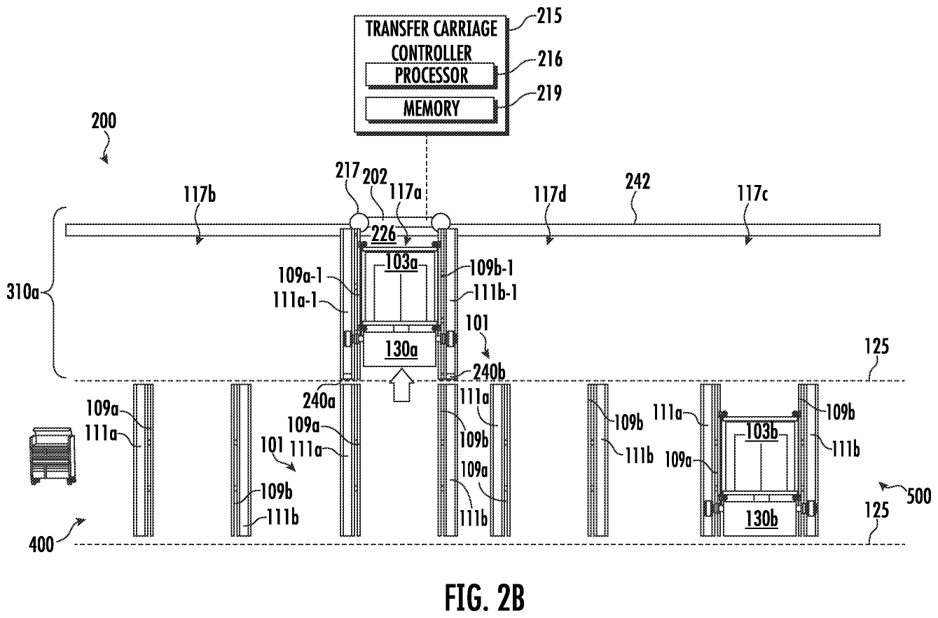

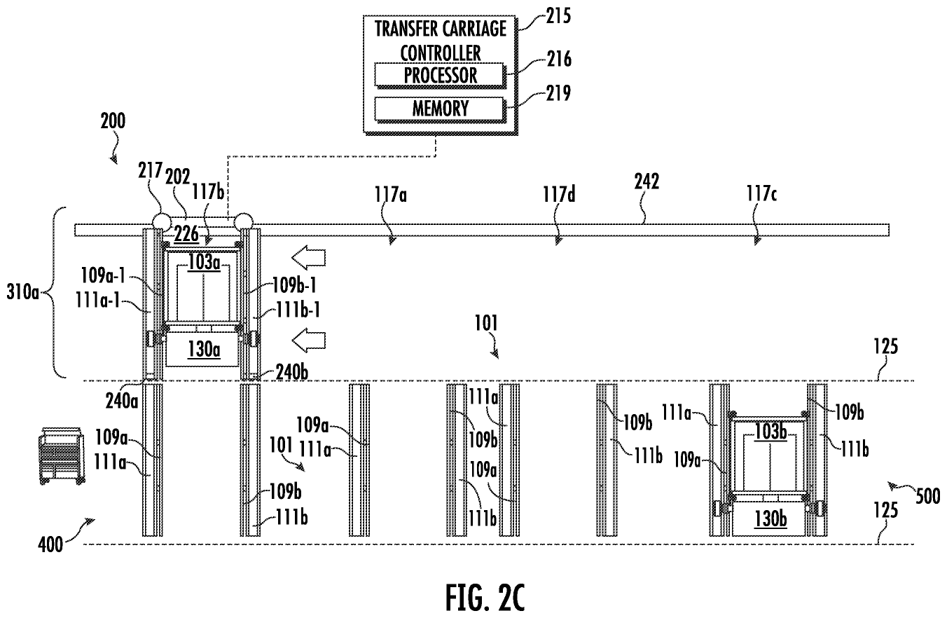

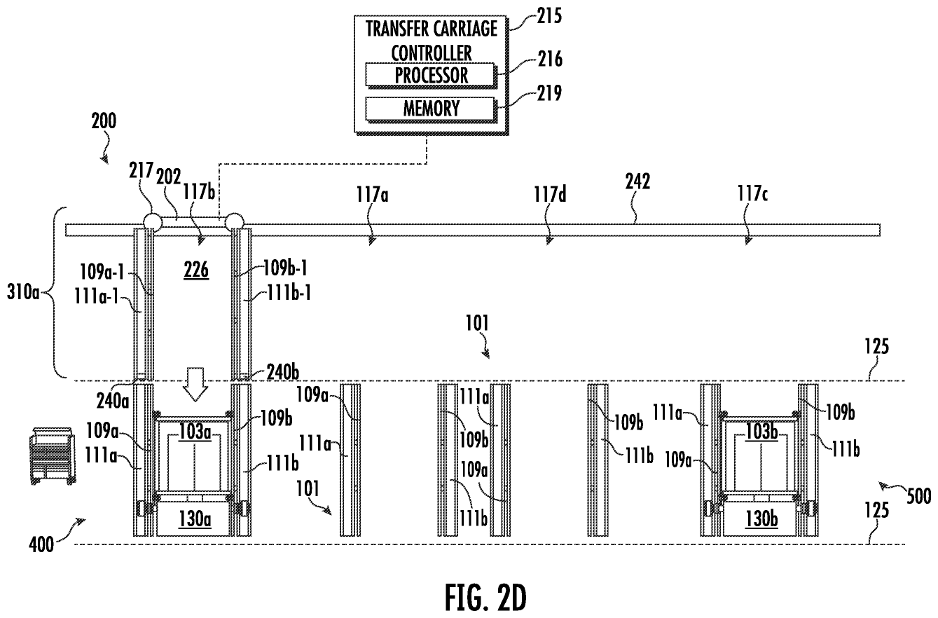

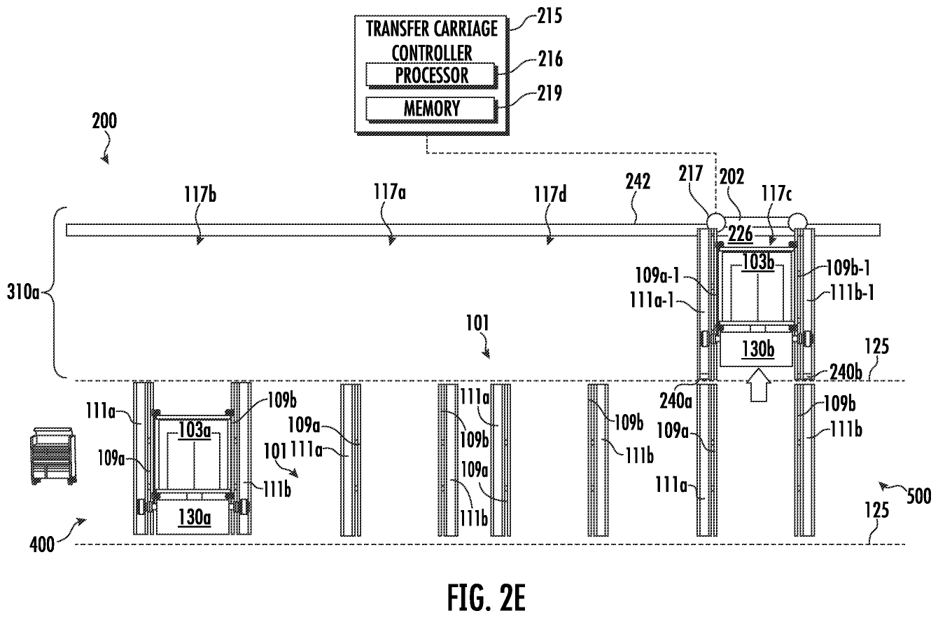

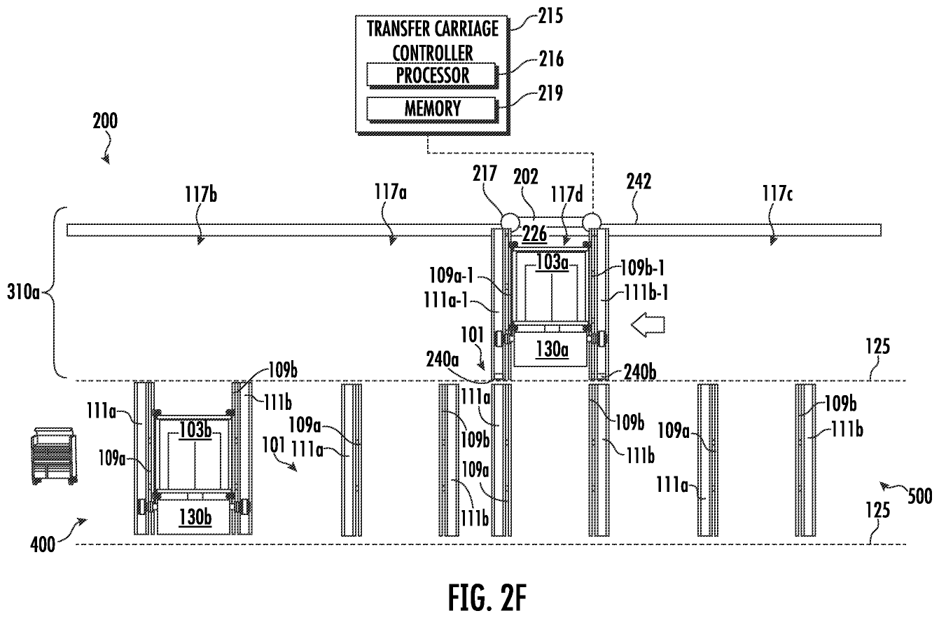

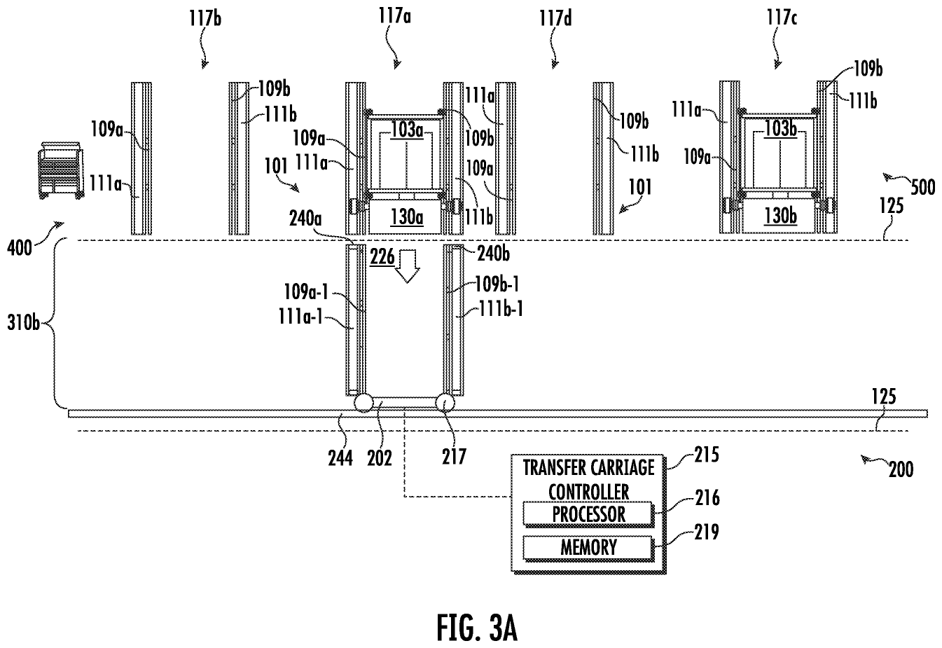

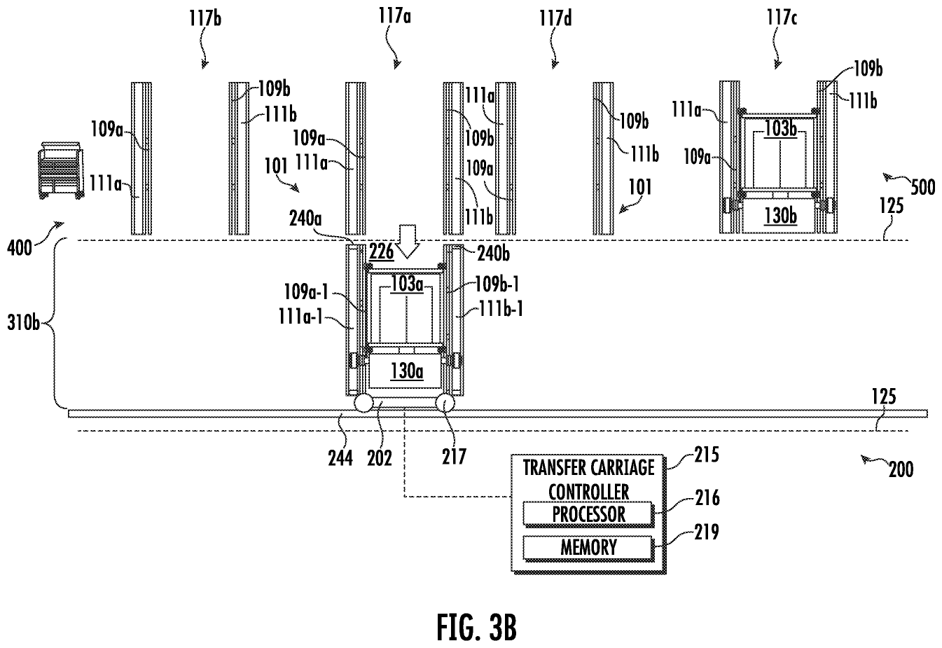

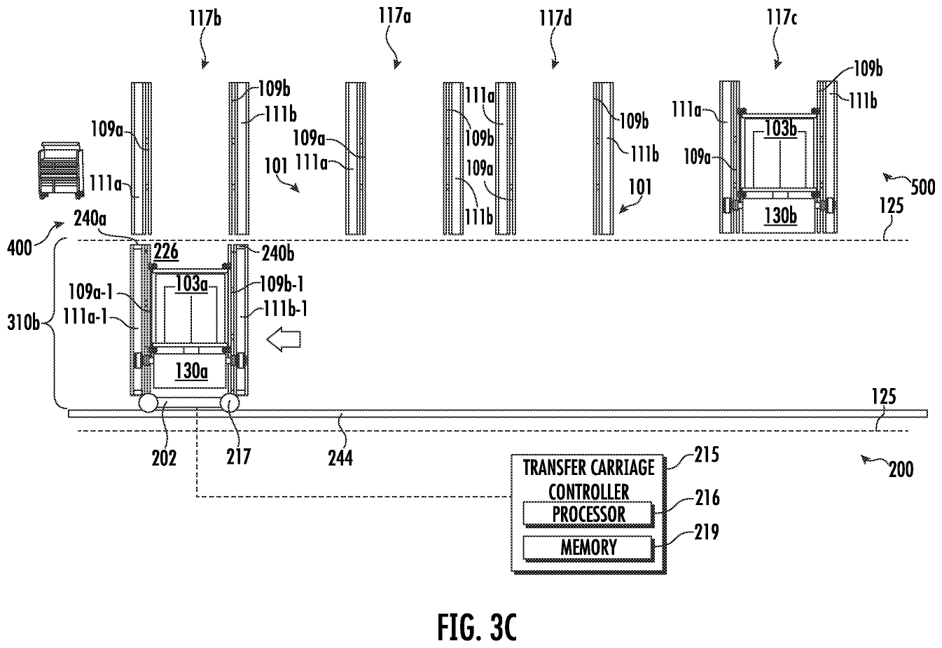

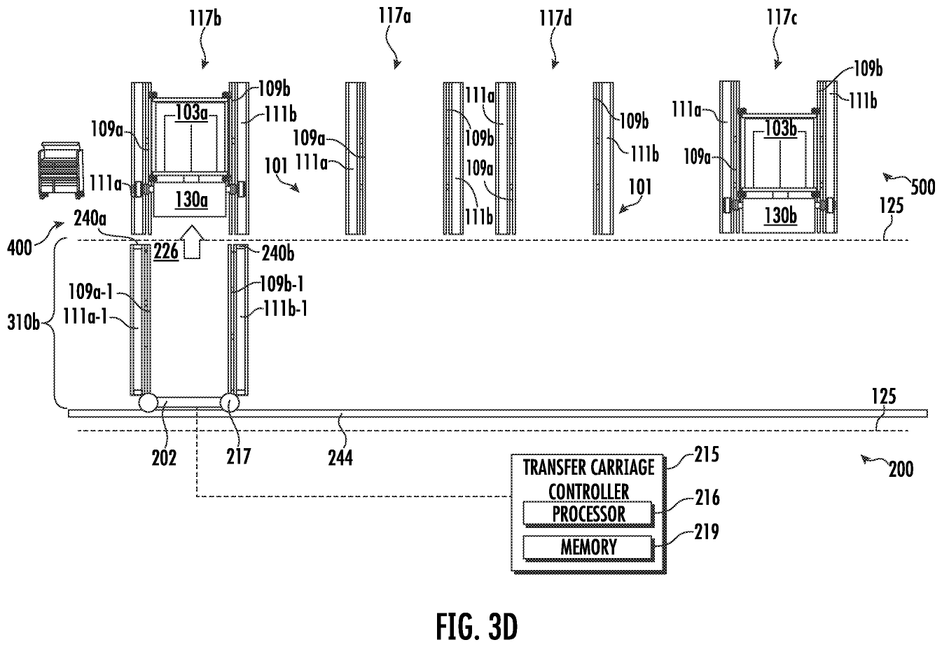

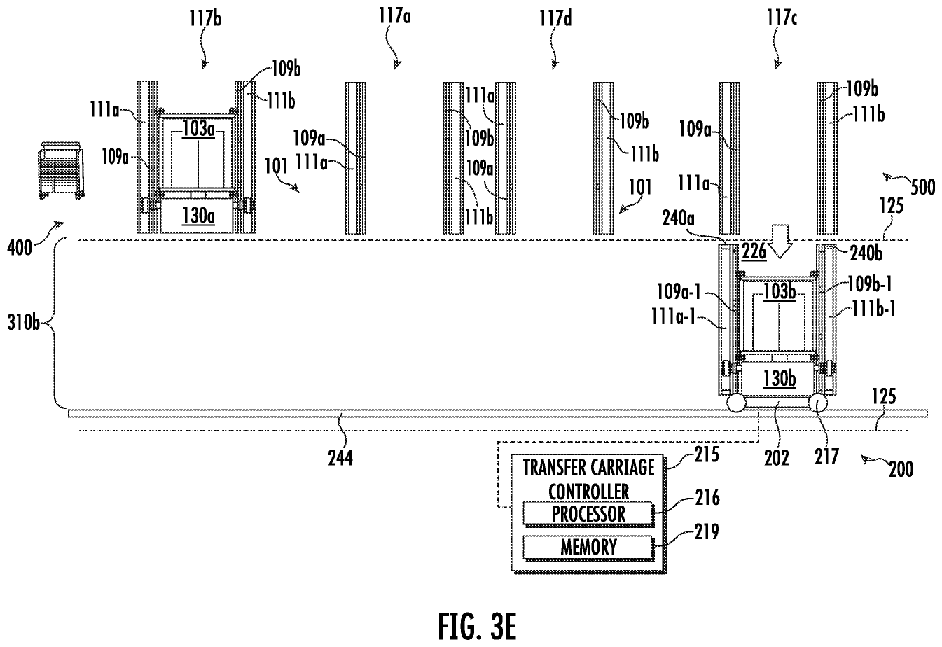

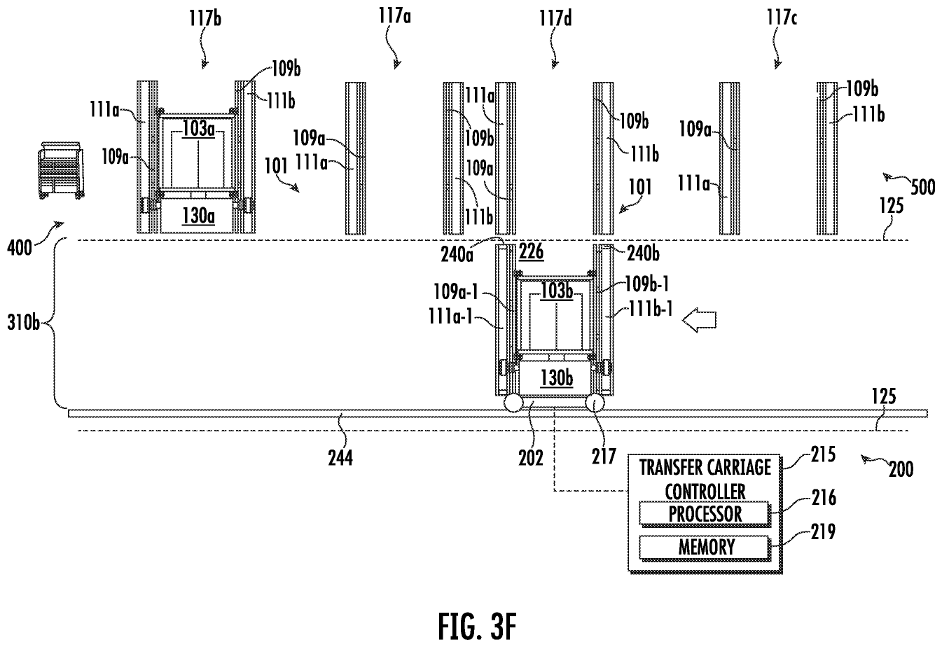

Referring now to FIGS. 2A, 2B, 2C, 2D, 2E, 2F, 3A, 3B, 3C, 3D, 3E, and 3F, with continued reference to FIG. 1, a transfer station system 200 for a transfer station 310a, 310b is illustrated, in accordance with an embodiment of the present disclosure. FIGS. 2A-2F is a side view of an upper transfer station 310a and FIGS. 3A-3F is a side view of a lower transfer station 310b.

The transfer carriage 202 may be a motorized and automated carriage. The transfer carriage 202 may move along a horizontal cross beam 242 in the upper transfer station 310a and a horizontal surface 244 of the elevator shaft 117a, 117b, 117c, 117d (i.e., a cross beam or a bottom of the elevator shaft 117a, 117b, 117c, 117d) in the lower transfer station 310b. The transfer carriage 202 may include a propulsive device (not shown for simplicity) to rotate wheels 217. The propulsive device may be an electric motor and associated wheels 217 or a permanent magnet motor. In an embodiment, the transfer carriage 202 is positioned above the elevator system 101 in an upper transfer station 310a, as illustrated in FIGS. 2A-2F. In an embodiment, the transfer carriage 202 is positioned beneath the elevator system 101 in a lower transfer station 310b, as illustrated in FIGS. 3A-3F. The transfer carriage 202 includes one or more elevator car containment slots 226 configured to receive and hold/secure the elevator car 103 and the beam climber system 130. The elevator car containment slot 226 may utilize a car retention mechanism to ensure that the elevator car 103 and the beam climber system 130 does not move during transportation by the transfer carriage 202 between elevator shafts 117a, 117b, 117c, 117d.

The first elevator shaft 117a and the fourth elevator shaft 117d may be passenger serving elevator shafts to transfer passengers between different landings 125. It is understood that while two passenger serving shafts are illustrated herein, the embodiments described herein may be applicable to one or more passenger serving elevator shafts. The second elevator shaft 117b and the third elevator shaft 117c may be passenger serving elevator shafts to transfer passengers between different landings 125 or they may be non-passenger serving elevator shafts. It is also understood that while a single transfer carriage 202 is illustrated herein, the embodiments described herein may be applicable to transfer station systems 200 includes one or more transfer carriages 202.

A second elevator shaft 117b may be utilized for a vehicle workstation 400 and a third elevator shaft 117c may be utilized for a spare vehicle station 500. It is understood that while a third elevator shaft 117c for a spare vehicle station 500 is illustrated, the embodiments disclosed herein may be applicable to systems without the third elevator shaft 117c for the spare vehicle station 500.

The transfer carriage 202 is configured to align an elevator car containment slot 226 with an elevator shaft 117a, 117b, 117c, 117d to receive and/or transfer a first elevator car 103a and a first beam climber system 130a into and out of service. The transfer carriage 202 may also be configured to align an elevator car containment slot 226 with an elevator shaft 117a, 117b, 117c, 117d to receive and/or transfer a second elevator car 103b and a second beam climber system 130b into and out of service.

Referring briefly to the example illustrated in FIGS. 2A-2F. In FIG. 2A the transfer carriage 202 may align the elevator car containment slot 226 with a first elevator shaft 117a to receive the first elevator car 103a in FIG. 2B. The first beam climber system 130a may then travel horizontally in the upper transfer station 310a to align the elevator car containment slot 226 with a second elevator shaft 117b in FIG. 2C to transfer the first elevator car 103a and the first beam climber system 130a to the vehicle workstation 400 within the second elevator shaft 117b in FIG. 2D. The transfer carriage 202 may then travel horizontally in the upper transfer station 310a to align the elevator car containment slot 226 with a third elevator shaft 117c and receive a second elevator car 103B and a second beam climber system 130b, as illustrated in FIG. 2E. The transfer carriage 202 may then travel horizontally in the upper transfer station 310a to align the elevator car containment slot 226 with either the first elevator shaft 117a or the fourth elevator shaft 117d in order to transfer the second elevator car 103b and the second beam climber system 130b into service, as illustrated in FIG. 2F.

Referring briefly to the example illustrated in FIGS. 3A-3F. In FIG. 3A the transfer carriage 202 may align the elevator car containment slot 226 with a first elevator shaft 117a to receive the first elevator car 103a in FIG. 3B. The first beam climber system 130a may then travel horizontally in the lower transfer station 310b to align the elevator car containment slot 226 with a second elevator shaft 117b in FIG. 3C to transfer the first elevator car 103a and the first beam climber system 130a to the vehicle workstation 400 within the second elevator shaft 117b in FIG. 3D. The transfer carriage 202 may then travel horizontally in the lower transfer station 310b to align the elevator car containment slot 226 with a third elevator shaft 117c and receive a second elevator car 103B and a second beam climber system 130b, as illustrated in FIG. 3E. The transfer carriage 202 may then travel horizontally in the lower transfer station 310b to align the elevator car containment slot 226 with either the first elevator shaft 117a or the fourth elevator shaft 117d in order to transfer the second elevator car 103b and the second beam climber system 130b into service, as illustrated in FIG. 3F.

While located in the vehicle workstation 400 work may be performed on the first elevator car 103a and/or the first beam climber system 130b. The vehicle workstation 400 may be located one landing below (as illustrated in FIGS. 2A-2F) or above the upper transfer station 310a, so that the transfer carriage 202 be may be free to move throughout the upper transfer station 310a to carry other elevator cars 103 after delivering the first elevator car 103a and the first beam climber system 130a to the vehicle workstation 400. The vehicle workstation 400 may be located one landing above (as illustrated in FIGS. 3A-3F) or below the lower transfer station 310b, so that the transfer carriage 202 be may be free to move throughout the upper transfer station 310a to carry other elevator cars 103 after delivering the first elevator car 103a and the first beam climber system 130a to the vehicle workstation 400. In an embodiment the vehicle workstation 400 may be on the same landing 125 as the upper transfer station 310a. In an embodiment the vehicle workstation 400 may be on the same landing 125 as the lower transfer station 310b. The vehicle workstation 400 may include work tools, including but not limited to, work platforms, test rigs, test equipment or any other tool known to one of skill in the art.

The spare vehicle station 500 may be located one landing below (as illustrated in FIGS. 2A-2F) or above the upper transfer station 310a, so that the transfer carriage 202 be may be free to move throughout the upper transfer station 310a to carry other elevator cars 103. The spare vehicle station 500 may be located one landing above (as illustrated in FIGS. 3A-3F) or below the lower transfer station 310b, so that the transfer carriage 202 be may be free to move throughout the upper transfer station 310a to carry other elevator cars 103. In an embodiment, the spare vehicle station 500 may be on the same landing 125 as the upper transfer station 310a. In an embodiment, the spare vehicle station 500 may be on the same landing 125 as the lower transfer station 310b.

In one embodiment, spare vehicle station 50 may provide for removing the elevator car 103 completely from the over all system. For example, the guide rails 109a, 109b and guide beams 111a, 111b located in the spare vehicle station 500 may be movable to move the elevator car 103 and beam climber system 130. For example, the guide rails 109a, 109b and guide beams 111a, 111b located in the spare vehicle station 500 may be connected to a dolly, a truck, a train, a trolly, or any other vehicle known by one of sill in the art. The elevator car containment slot 226 may include a first containment slot guide beam 111a-1 and a second containment slot guide beam 111b-1. The first containment slot guide beam 111a-1 is configured to align with the first guide beam 111a so that the wheels 134a, 134b (see FIG. 1) may roll from the first guide beam 111a to the first containment slot guide beam 111a-1 when the beam climber system 130 is leaving the elevator shaft 117 and entering the elevator car containment slot 226 to ride the transfer carriage 202. The transfer carriage 202 may include a first sensor 240a configured to detect when the first containment slot guide beam 111a-1 is aligned with the first guide beam 111a. It is understood that the transfer carriage 202 may include other sensors including but not limited to micro-switches, gap sensors or broken beam sensors.

The second slot containment guide beam 111b-1 is configured to align with the second guide beam 111b so that the wheels 134c, 134d (see FIG. 1) may roll from the second guide beam 111b to the second slot containment guide beam 111b-1 when the beam climber system 130 is leaving the elevator shaft 117 and entering the elevator car containment slot 226 to ride the transfer carriage 202. The transfer carriage 202 may include a second sensor 240b configured to detect when the second containment slot guide beam 111b-1 is aligned with the second guide beam 111b.

The first containment slot guide rail 109a-1 is configured to align with the first guide rail 109a. The first sensor 240a may be configured to detect when the first containment slot guide rail 109a-1 is aligned with the first guide rail 109a.

The second slot containment guide rail 109b-1 is configured to align with the second guide rail 109b. The transfer carriage 202 may include a second sensor 240b configured to detect when the second containment slot guide rail 109b-1 is aligned with the second guide rail 109b.

It is understood that while FIGS. 2A-3F illustrates the transfer carriage 202 as including two sensors 240a, 240b, the transfer station system 200 may include any number of sensors (i.e., one or more sensors) to ensure alignment of the first containment slot guide beam 111a-1 with the first guide beam 111a, the second slot containment guide beam 111b-1 with the second guide beam 111b, the first containment slot guide rail 109a-1 with the first guide rail 109a, and the second slot containment guide rail 109b-1 with the second guide rail 109b.

The sensors 240a, 240b are configured to communicate alignment to the controller 115 (see FIG. 1) of the beam climber system 130, so that the beam climber system 130 may move itself and the elevator car 103 into an elevator car containment slot 226 of the transfer carriage 202. The sensors 240a, 240b are also configured to communicate misalignment to the controller 115 (see FIG. 1) of the beam climber system 130 to prevent the beam climber system 130 from attempting to move itself and the elevator car 103 into an elevator car containment slot 226 of the transfer carriage 202 that is not misaligned.

The sensors 240a, 240b are configured to communicate alignment or misalignment to a transfer carriage controller 215 of the transfer carriage 202. The transfer carriage controller 215 is configured to control operations of the transfer carriage 202. By reporting misalignment to the transfer carriage controller 215, the transfer carriage controller 215 may then take action to achieve alignment, such as moving laterally. By reporting alignment to the transfer carriage controller 215, the transfer carriage controller 215 may no longer need to move the transfer carriage 202 until the elevator car 103 and the beam climber system 130 move from the elevator system 101 in the elevator shaft 117a, 117b, 117c, 117d into and out of the elevator car containment slot 226 of the transfer carriage 202.

The transfer carriage controller 215 may be an electronic controller including a processor 216 and an associated memory 219 comprising computer-executable instructions that, when executed by the processor 216, cause the processor 216 to perform various operations. The processor 216 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 219 may be but is not limited to a random access memory (RAM), read only memory (ROM), or other electronic, optical, magnetic or any other computer readable medium.

Although illustrated in FIGS. 2A-3F as a separate controller, it is understood that the transfer carriage controller 215 may be a separate controller from the controller 115 of the beam climber system or the transfer carriage controller 215 may be a combined controller with the controller 115 of the beam climber system 130. Additionally, the transfer carriage controller 215 may be a cloud controller or the transfer carriage controller 215 may be a local controller.

Although illustrated in FIGS. 2A-3F as separate from the transfer carriage 202, the embodiments described herein may be applicable to a transfer carriage controller 215 located in the transfer carriage 202 (i.e., moving with the transfer carriage 202) or located in a cloud computing network.

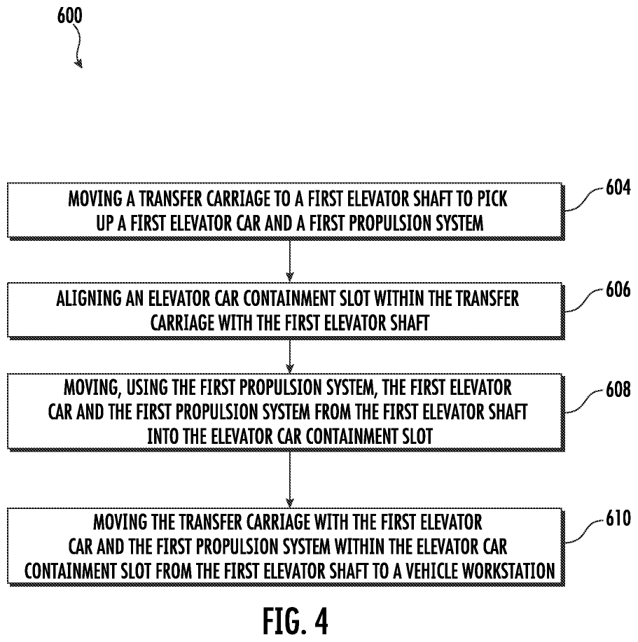

Referring now to FIG. 4, with continued reference to the previous FIGS., a flow chart of a method 600 of moving elevator cars 103 amongst elevator shafts 117 is illustrated, in accordance with an embodiment of the disclosure.

At block 604, a transfer carriage 202 is moved to a first elevator shaft 117a to pick up a first elevator car 103a and a first propulsion system. At block 606, an elevator car containment slot 226 within the transfer carriage 202 is aligned with the first elevator shaft 117a.

At block 608, the first propulsion system moves the first elevator car 103a from the first elevator shaft 117a into the elevator car containment slot 226. In an embodiment, the first propulsion system is a first beam climber system 130a and the first elevator car 103a may be moved by rotating a first wheel 134a using a first electric motor 132 of the first beam climber system 130a. The first wheel 134a being in contact with a first surface 112a of a first guide beam 111a that extends vertically through the elevator shaft 117.

At block 610 the transfer carriage 202 is moved with the first elevator car 103a and the first propulsion system within the elevator car containment slot 226 from the first elevator shaft 117a to a second elevator shaft 117b.

The method 600 may further comprise that the elevator car containment slot 226 within the transfer carriage 202 is aligned with the second elevator shaft 117b and the first propulsion system moves the first elevator car 103a and the first propulsion system from the elevator car containment slot 2226 into the vehicle workstation 400 within the second elevator shaft 117b.

The method 600 may further comprise that the moving the transfer carriage 202 from the second elevator shaft 117b to a third elevator shaft 117c to pick up a second elevator car 103b and a second propulsion system in a spare vehicle station 500 within the third elevator shaft 117c. The elevator car containment slot 226 within the transfer carriage 202 may be aligned with the third elevator shaft 117c and the second propulsion system may move the second elevator car 103b and the second propulsion system from the spare vehicle station 500 within third elevator shaft 117c into the elevator car containment slot 226.

The method 600 may further comprise that the transfer carriage 202 with the second elevator car 103b and the second propulsion system within the elevator car containment slot 226 is moved from the third elevator shaft into service (e.g., into the first elevator shaft 117a or the fourth elevator shaft 117d).

The method 600 may also comprise aligning a first containment slot guide beam 111a-1 of the elevator car containment slot 226 with the first guide beam 111a. The method 600 may further comprise aligning a first containment slot guide rail 109a-1 of the elevator car containment slot 226 with a first guide rail 109a that extends vertically through the first elevator shaft 117a.

The first elevator car 103a may also be moved by rotating, using a second electric motor 132b of the beam climber system 130, a third wheel 134c, the third wheel being in contact with a first surface 112c of a second guide beam 111b that extends vertically through the first elevator shaft 117a.

The method 600 may also comprise aligning a second containment slot guide beam 111b-1 of the elevator car containment slot 226 with the second guide beam 111b. The method 600 may further comprise aligning a second containment slot guide rail 109b-1 of the elevator car containment slot 226 with a second guide rail 109b that extends vertically through the first elevator shaft 117a.

While the above description has described the flow process of FIG. 4 in a particular order, it should be appreciated that unless otherwise specifically required in the attached claims that the ordering of the steps may be varied.

The present invention may be a system, a method, and/or a computer program product at any possible technical detail level of integration. The computer program product may include a computer readable storage medium (or media) having computer readable program instructions thereon for causing a processor to carry out aspects of the present invention.

As described above, embodiments can be in the form of processor-implemented processes and devices for practicing those processes, such as processor. Embodiments can also be in the form of computer program code (e.g., computer program product) containing instructions embodied in tangible media (e.g., non-transitory computer readable medium), such as floppy diskettes, CD ROMs, hard drives, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an device for practicing the exemplary embodiments. When implemented on a general-purpose microprocessor, the computer program code segments configure the microprocessor to create specific logic circuits.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A system for transferring elevator cars from a first elevator shaft to a second elevator shaft, the system comprising:
a first propulsion system configured to move a first elevator car through the first elevator shaft;
a transfer carriage configured to move the first elevator car and the first propulsion system from the first elevator shaft to the second elevator shaft through a transfer station, the transfer carriage comprising:
an elevator car containment slot to receive the first elevator car and the first propulsion system when the elevator car containment slot is aligned with the first elevator shaft,
wherein the first propulsion system is configured to move the first elevator car and the first propulsion system from an elevator system within the first elevator shaft onto the transfer carriage to a vehicle workstation.

2. The system of claim 1, wherein the vehicle workstation is located on a landing below the transfer station, a landing above the transfer station or on the same landing as the transfer station.

3. The system of claim 1, wherein the vehicle workstation is located within the second elevator shaft, and wherein transfer carriage is configured to move from the second elevator shaft to a third elevator shaft through transfer station to receive a second elevator car and a second propulsion system from a spare vehicle station.

4. The system of claim 1, further comprising:
a first guide beam that extends vertically through the first elevator shaft, the first guide beam comprising a first surface and a second surface opposite the first surface,
wherein the first propulsion system is a first beam climber system comprising:
a first wheel in contact with the first surface; and
a first electric motor configured to rotate the first wheel.

5. The system of claim 4, wherein the elevator car containment slot further comprises:
a first containment slot guide beam configured to align with the first guide beam.

6. The system of claim 5, further comprising
a first guide rail that extends vertically through the first elevator shaft,
wherein the elevator car containment slot further comprises:
a first containment slot guide rail configured to align with the first guide rail.

7. The system of claim 5, further comprising
a second guide beam that extends vertically through the first elevator shaft, the second guide beam comprising a first surface of the second guide beam and a second surface of the second guide beam opposite the first surface of the second guide beam,
wherein the first beam climber system further comprises:
a second wheel in contact with the second surface of the first guide beam;
a third wheel in contact with the first surface of the second guide beam; and
a second electric motor configured to rotate the third wheel.

8. The system of claim 7, wherein the elevator car containment slot further comprises:
a second containment slot guide beam configured to align with the second guide beam.

9. The system of claim 6, further comprising
a second guide beam that extends vertically through the first elevator shaft, the second guide beam comprising a first surface of the second guide beam and a second surface of the second guide beam opposite the first surface of the second guide beam,
wherein the first beam climber system further comprises:
a second wheel in contact with the second surface of the first guide beam;
a third wheel in contact with the first surface of the second guide beam; and
a second electric motor configured to rotate the third wheel.

10. The system of claim 9, wherein the elevator car containment slot further comprises:
a second containment slot guide beam configured to align with the second guide beam.

11. The system of claim 10, further comprising
a second guide rail that extends vertically through the first elevator shaft,
wherein the elevator car containment slot further comprises:
a second containment slot guide rail configured to align with the second guide rail.

12. A method of moving elevator cars amongst elevator shafts, the method comprising:
moving a transfer carriage to a first elevator shaft to pick up a first elevator car and a first propulsion system;
aligning an elevator car containment slot within the transfer carriage with the first elevator shaft;
moving, using the first propulsion system, the first elevator car and the first propulsion system from the first elevator shaft into the elevator car containment slot; and
moving the transfer carriage with the first elevator car and the first propulsion system within the elevator car containment slot from the first elevator shaft to a vehicle workstation.

13. The method of claim 12, wherein the vehicle workstation is located in a second elevator shaft, and wherein the method further comprises:
aligning the elevator car containment slot within the transfer carriage with the second elevator shaft; and
moving, using the first propulsion system, the first elevator car and the first propulsion system from the elevator car containment slot into the vehicle workstation within the second elevator shaft.

14. The method of claim 13, further comprising:
moving the transfer carriage from the second elevator shaft to a third elevator shaft to pick up a second elevator car and a second propulsion system in a spare vehicle station within the third elevator shaft;
aligning the elevator car containment slot within the transfer carriage with the third elevator shaft; and
moving, using the second propulsion system, the second elevator car and the second propulsion system from the spare vehicle station within the third elevator shaft into the elevator car containment slot.

15. The method of claim 14, further comprising:
moving the transfer carriage with the second elevator car and the second propulsion system within the elevator car containment slot from the third elevator shaft into service.

16. The method of claim 12, wherein the moving, using the first propulsion system, the first elevator car and the first propulsion system from the first elevator shaft into the elevator car containment slot further comprises:
rotating, using a first electric motor of a first beam climber system, a first wheel, the first wheel being in contact with a first surface of a first guide beam that extends vertically through the first elevator shaft.

17. The method of claim 16, further comprising:
aligning a first containment slot guide beam of the elevator car containment slot with the first guide beam.

18. The method of claim 17, further comprising:
aligning a first containment slot guide rail of the elevator car containment slot with a first guide rail that extends vertically through the first elevator shaft.

19. The method of claim 16, wherein the moving, using the first propulsion system, the first elevator car and the first propulsion system from the first elevator shaft into the elevator car containment slot further comprises:
rotating a second wheel, the second wheel being in contact with the second surface of the first guide beam that extends vertically through the elevator shaft; and
rotating, using a second electric motor of the beam climber system, a third wheel, the third wheel being in contact with a first surface of a second guide beam that extends vertically through the first elevator shaft.

20. A computer program product embodied on a non-transitory computer readable medium, the computer program product including instructions that, when executed by a processor, cause the processor to perform operations comprising:
moving a transfer carriage to a first elevator shaft to pick up a first elevator car and a first propulsion system;
aligning an elevator car containment slot within the transfer carriage with the first elevator shaft;
moving, using the first propulsion system, the first elevator car and the first propulsion system from the first elevator shaft into the elevator car containment slot; and
moving the transfer carriage with the first elevator car and the first propulsion system within the elevator car containment slot from the first elevator shaft to a vehicle workstation.
